(19) United States
(12) Patent Application Publication
(10) Pub. No.: US 2006/0176162 A1
(43) Pub. Date: Aug. 10, 2006

(54) Method and device for detecting when a motorcycle is lying on its side

(76) Inventors: Klaus Miekley, Ludwigsburg (DE); Joerg Huttenlocher, Rutesheim (DE)

Correspondence Address: KENYON & KENYON LLP, ONE BROADWAY, NEW YORK, NY, 10004, US

(21) Appl. No.: 11/332,686

(22) Filed: Jan. 12, 2006

(30) Foreign Application Priority Data
Jan. 18, 2005 (DE) 102005002239.1

(51) Int. Cl. B60Q 1/00; B60K 28/00

(52) U.S. Cl. 340/440; 180/271

(57) ABSTRACT

A method for detecting when a vehicle is lying on its side, in which a measuring signal is ascertained using an acceleration sensor, which is mounted in such a way that its measuring direction is oriented parallel with respect to the vertical axis of the vehicle, and the measuring signal is used to detect when the vehicle is lying on its side.

### FIELD OF THE INVENTION

The present invention relates to a method for detecting if a vehicle is lying on its side and to the associated device.

### SUMMARY OF THE INVENTION

The present invention relates to a method for detecting if a vehicle is lying on its side or transversely or horizontally in which
a measuring signal is ascertained using an acceleration sensor or inertial sensor, which is mounted in such a way that its measuring direction points in the vertical direction of the vehicle or is oriented parallel with respect to the vertical axis of the vehicle, and
the measuring signal is used to detect when the vehicle is lying on its side.

An advantageous refinement of the present invention is characterized by the fact that the vehicle is recognized as lying on its side if the acceleration value detected from the output signal of the acceleration sensor or the acceleration value corresponding to the output signal of the acceleration sensor falls below a specified threshold value. In this context, the term “acceleration value” comprises not only the acceleration of the vehicle (see e.g. the transversal acceleration component aq in FIG. 1b)), but also the component of the gravitational acceleration g pointing in the measuring direction (see e.g. the gravitational acceleration component g in FIG. 1b)).

An advantageous refinement of the present invention is characterized by the fact that the threshold value is selected to be substantially lower than the value of the gravitational acceleration. This avoids false detections that the vehicle is lying on its side.

The present invention further comprises a device for detecting if a vehicle is lying on its side, including
an acceleration sensor or inertial sensor, which is mounted in such a way that its measuring direction is oriented parallel with respect to the vertical axis of the vehicle, for ascertaining a measuring signal and
evaluation means for detecting when the vehicle is lying on its side from the measuring signal.

One advantageous refinement of the present invention is characterized by the fact that the vehicle is a single-track vehicle.

One advantageous refinement of the present invention is characterized by the fact that the vehicle is a motorcycle.

One advantageous refinement of the present invention is characterized by the fact that the acceleration sensor is an inertial sensor.

One advantageous refinement of the present invention is characterized by the fact that the acceleration sensor is sensor based on the spring-mass principle.

The advantageous refinements of the method according to the present invention manifest themselves also as advantageous refinements of the device according to the present invention, and vice versa.

### BRIEF DESCRIPTION OF THE DRAWINGS

FIG. 1 shows a motorcycle in three different positions.

FIG. 2 shows the sequence of the method according to the present invention.

FIG. 3 shows the construction of the device according to the present invention.

### DETAILED DESCRIPTION

The present invention makes it possible to detect reliably when a vehicle is lying on its side, particularly a motorcycle or two-wheeler. Detecting when a vehicle is lying on its side is important, for example, for turning off the engine automatically in this case so as to avert consequential faults in the engine due to a loss of a sufficient lubrication.

According to the present invention, an acceleration sensor is mounted to the motorcycle in such a way that the acceleration acting in the vertical axis direction of the motorcycle (or the acceleration value corresponding to the inertial force acting in the vertical axis direction) is measured.

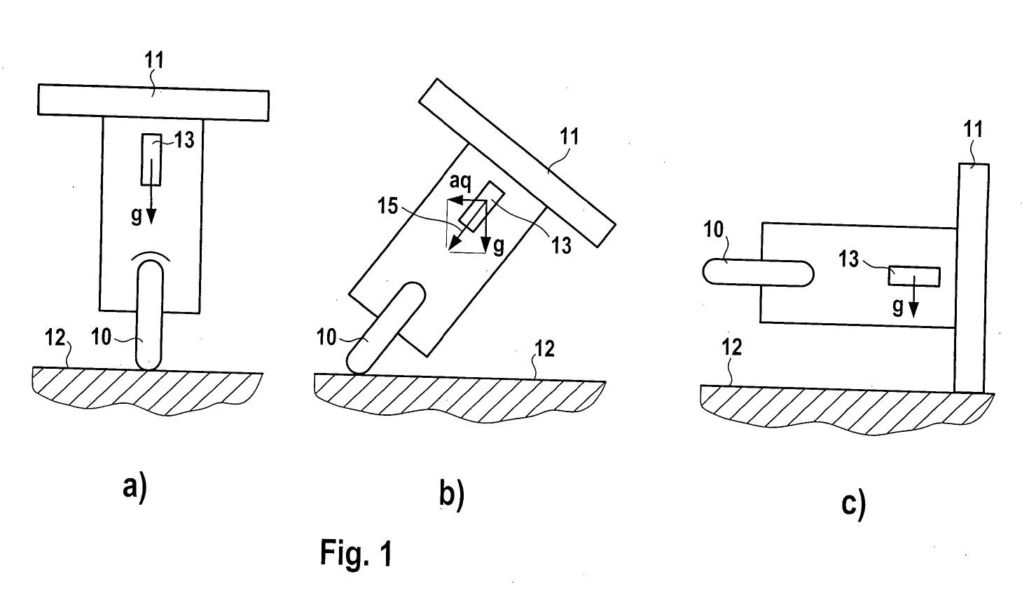

To this end, FIG. 1 shows a very schematic front view of three different positions of a motorcycle. In each case, the reference numerals indicate the following:
10=front wheel,
11-handlebar,
12=roadway,
13=vertically mounted acceleration sensor. The measuring direction of the acceleration sensor always points into the elongated dimension of the sensor, i.e. e.g. in FIG. 1a) in the vertical direction and in FIG. 1c) in the horizontal direction.

The acceleration values measured in the three positions of the motorcycle indicated in FIG. 1 as a), b) and c) are explained in the following.

Motorcycle Position as Shown in FIG. 1a):

FIG. 1a) shows a motorcycle standing upright. Since the measuring direction of sensor 13 points in the vertical direction, sensor 13 measures here the gravitational acceleration g (g≈9.81 m/s²).

Motorcycle Position as Shown in FIG. 1b):

FIG. 1b) shows a motorcycle inclined while cornering. In this case, the acceleration sensor measures the signal indicated by vector arrow 15, which is composed of the vectorial sum
of the gravitational acceleration g pointing vertically downward and
the transversal acceleration aq pointing horizontally in the direction of the outside of the curve. From FIG. 1b) it is immediately clear that the length of vector arrow 15 is greater than the length of vector arrow g. This means that during cornering the acceleration sensor measures an acceleration greater than g.
   Motorcycle Position as Shown in FIG. 1c):

FIG. 1c) shows a motorcycle lying on the ground. Here the indicated gravitational acceleration g points in a direction perpendicular or approximately perpendicular with respect to the measuring direction of the acceleration sensor, i.e. acceleration sensor 13 measures the value zero or a value of approximately zero (since in practice the motorcycle often does not lie absolutely level with respect to the ground).

The described installation position of the acceleration sensor with the measuring axis pointing in the vertical direction of the motorcycle allows for a very reliable detection of the transverse position of the motorcycle. The transverse position is detected by the fact that the acceleration measured by sensor 13 lies substantially below gravitational acceleration g. A false detection of a transverse position during cornering is not possible for the reason that the sensor during cornering measures an even greater acceleration than the gravitational acceleration g (see FIG. 1b)).

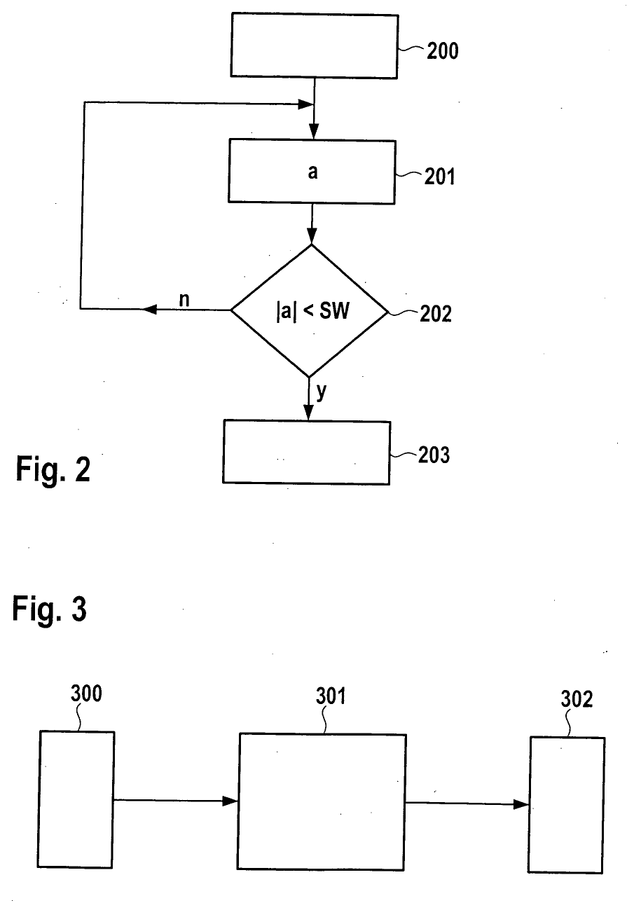

The sequence of the method according to the present invention is shown in FIG. 2. Following the start of the method in block 200, the acceleration component a acting in the measuring direction of the acceleration sensor is measured in block 201. Subsequently, a query is made in block 202 as to whether the magnitude of a falls below a threshold value SW. If the answer is “no” (indicated by “n” in FIG. 2), then the system branches back to block 201. If the response is “yes” (indicated in FIG. 2 by “y”), then it is determined in block 203 that the vehicle is lying on its side.

FIG. 3 shows the structure of the device for detecting when a vehicle is lying on its side.

Acceleration sensor 300, which is mounted in such a way that its measuring direction points parallel with respect to the vertical axis of the vehicle, supplies its output signals to evaluation means 301 for detecting on the basis of the measuring signal whether the vehicle is lying on its side. In the event that the vehicle is found to lie on its side, the evaluation means trigger, for example, engine control 302, causing the engine to switch off.

The present invention for detecting when a vehicle is lying on its side is not only suitable for motorcycles, but can be used for all types of vehicles.

What is claimed is:

1. A method for detecting when a vehicle is lying on its side, comprising:
ascertaining a measuring signal using an acceleration sensor, which is mounted in such a way that its measuring direction is oriented parallel with respect to a vertical axis of the vehicle; and
detecting on the basis of the measuring signal when the vehicle is lying on its side.

2. The method according to claim 1, wherein the vehicle is recognized to lie on its side if an acceleration value corresponding to an output signal of the acceleration sensor falls below a specified threshold value.

3. The method according to claim 2, wherein the threshold value is substantially lower than a value of a gravitational acceleration.

4. A device for detecting when a vehicle is lying on its side, comprising:
an acceleration sensor mounted in such a way that its measuring direction is pointing parallel with respect to a vertical axis of the vehicle, for ascertaining a measuring signal; and
evaluation means for detecting when the vehicle is lying on its side as a function of the measuring signal.

5. The device according to claim 4, wherein, in the evaluation means, the vehicle is recognized to lie on its side if an acceleration value corresponding to an output signal of the acceleration sensor falls below a specified threshold value.

6. The device according to claim 5, wherein the threshold value is substantially lower than a value of a gravitational acceleration.

7. The device according to claim 4, wherein the vehicle is a single-track vehicle.

8. The device according to claim 7, wherein the vehicle is a motorcycle.

9. The device according to claim 4, wherein the acceleration sensor is an inertial sensor.

10. The device according to claim 4, wherein the acceleration sensor is a sensor based on the spring-mass principle.
